(19) United States
(12) Patent Application Publication
(10) Pub. No.: US 2024/0240078 A1
(43) Pub. Date: Jul. 18, 2024

(54) NUCLEIC ACID FUNCTIONALIZED METAL NANOPROBE AND PREPARATION METHOD THEREFOR

(71) Applicant: SOUTHEAST UNIVERSITY, Nanjing (CN)

(72) Inventors: Xuemei WANG, Nanjing (CN); Zengchao GUO, Nanjing (CN); Jiayu ZENG, Nanjing (CN); Hui JIANG, Nanjing (CN)

(21) Appl. No.: 18/013,928

(22) PCT Filed: Nov. 10, 2021
(86) PCT No.: PCT/CN2021/129724

§ 371 Date: Dec. 30, 2022

(30) Foreign Application Priority Data
Feb. 25, 2021 (CN) 202110212038.5

(51) Int. Cl. C09K 11/58; B82Y 20/00; B82Y 40/00; G01N 21/64

(52) U.S. Cl. CPC C09K 11/58; G01N 21/6458; B82Y 20/00; B82Y 40/00; G01N 2021/6439

(57) ABSTRACT

Disclosed are a nucleic acid functionalized metal nanoprobe and a preparation method therefor; according to the probe, metal cations with desirable biocompatibility are mixed with exogenous deoxyribonucleic acid (DNA) or ribonucleic acid (RNA) molecules to generate a DNA or RNA composite nanostructure; co-incubating is performed with a pathogenic microorganism, the composite nanostructure enters pathogenic microorganism cells through electrostatic adsorption, and unique microenvironment of high-level oxidizing and reducing substances possessed by the pathogenic microorganism is used to promote in-situ synthesis of the intelligent biological probe; accurate targeted labeling and real-time rapid detection of the pathogenic microorganism are achieved, and the probe is used for targeted intervention of infectious diseases such as lung infection, intestinal infection and influenza; combined with physical interventions such as photoelectricity, magnetocaloric effect, near infrared, multi-modal real-time dynamic and high-specificity rapid and accurate tracing and accurate killing of related lesions can be achieved.

### TECHNICAL FIELD

The present disclosure relates to the field of biomaterials, in particular to a nucleic acid functionalized metal nanoprobe, an in-situ construction preparation method therefor and a method for treating an infectious disease using same.

### BACKGROUND ART

Bacteria and viruses are ubiquitous in nature. Human body at the temperature around 37° C. and moist mucosa in the body are breeding grounds for bacteria. In recent years, emerging or sudden diseases, such as highly pathogenic avian influenza, atypical pneumonia and viral pneumonia, have been constantly springing up, which brings great troubles to clinical diagnosis and treatment. As a result, in the case of pathogenic microorganisms, early diagnosis and treatment and early control are required for effectively reducing physical damage and threats to human health. Although there exist numerous methods for detecting pathogenic microorganisms, such as plate culture, enzyme-linked immunosorbent assay, polymerase chain reaction (PCR) and sequencing, they are usually complicated and time-consuming processes, and sometimes have a series of problems, for example, false positive or low sensitivity. Apart from the diagnosis, the treatment problem is increasingly severe. After invention of penicillin, antibiotics play a crucial part in fighting off various pathogenic microorganisms. However, overuse of the antibiotics causes the pathogenic microorganisms to mutate and become resistant to the antibiotics, and many drug-resistant strains to come out accordingly, which greatly reduces the therapeutic effect of the antibiotics. In view of this, it is urgent to establish a simple, sensitive and reliable new detection technology for the pathogenic microorganisms and develop a safe, efficient and effective treatment strategy. Since metal nano-materials have unique physical and chemical properties, such as light, electricity and magnetism, nanotechnology has attracted extensive attention in the diagnosis and treatment of the pathogenic microorganisms in recent years. Generally, metal nanoprobes are synthesized by using macromolecular substances such as protein and nucleic acid as templates for stabilizing their structures, which is crucial upon their application. However, synthesis methods have harsh requirements for conditions, for example, high temperature and narrow acid-base range. Besides, current research mainly focuses on use of the metal nanomaterials as drug carriers. In recent years, a strategy of in-situ self-assembly synthesis of metal nanoprobes has been reported frequently. The method not only omits additional chemical reagents for preventing nanoprobes from agglomerating, but also can detect target cells in real time. Biomaterials of nucleic acids such as DNA have low cytotoxicity and high biocompatibility, and can be used as desirable self-assembly materials in vivo on account of their precise base complementary pairing. But, foreign genes can often enter pathogenic microbial cells through special treatments such as transfection and transformation, which greatly reduces the possibility of targeting the pathogenic bacteria in vivo with foreign genes as templates. Therefore, delivery of exogenous nucleic acid molecules into the pathogenic microbial cells and in-situ generation of functionalized nanoprobes by combining metal cations can eliminate the side effects caused by nanoparticles, further effectively combine biological imaging technology with therapeutic means, integrate diagnosis and treatment, and reduce the organism harm caused by excessive use of exogenous substances.

Disclosed in China's authorized patent with publication No. of CN1435493A are a solid-phase nucleic acid detection probe and a preparation method therefor, specifically, are an oligonucleotide probe fixed on a solid substrate and a microarray chip manufactured with the method, and is an unlabeled oligonucleotide probe for detecting a nucleic acid sequence. The probe has a fluorescence quenching material 3 fixed on the solid substrate 1 by means of an arm molecule 2. An oligonucleotide probe composed of a fluorescent group 5, a stem portion 6 of an oligonucleotide probe molecule and a loop 7 of the oligonucleotide probe is prepared on a surface of the fluorescence quenching material 3. An end of the oligonucleotide probe is fixed on the surface of the fluorescence quenching material 3, and a base near the other end of the oligonucleotide probe is marked with the fluorescent group 5. Sequences near two ends of the oligonucleotide probe separately include 3-15 complementary sequences of basic groups, and can be made to hybridize accordingly. A base sequence in a middle of the oligonucleotide probe is a complementary sequence to a nucleic acid sequence to be detected.

The patent application with publication No. of CN105021585A discloses a method for detecting food-borne pathogenic bacteria based on a metal-organic framework material-nucleic acid aptamer fluorescence sensor. According to the method of the present disclosure, based on the fluorescence quenching features of the metal-organic framework material and adsorption of a nucleic acid aptamer, when the nucleic acid aptamer labeled by a fluorescent probe is adsorbed onto the metal-organic framework material, fluorescence of the probe is quenched, target bacteria are added into the system, the nucleic acid aptamer labeled by the fluorescent probe leaves the metal-organic framework material to be combined with the target bacteria, such that a fluorescent signal of the probe is enhanced, and the high affinity and high specificity recognition ability of the nucleic acid aptamer are combined. Salmonella is used as a model analyte, and the fluorescence intensity of the probe is in a desirable linear relation with a logarithm of a target bacteria concentration. The linear range is 18-3.2×104 cfu/mL, the detection limit is 5 cfu/mL (S/N=3), the relative standard deviation (RSD) of a spike experiment is 3.6%-7.5%, and the recovery rate is 90.0%-106.0%. The present disclosure has the advantages of accuracy, sensitivity, high specificity, etc. when used for detecting the food-borne pathogenic bacteria.

As described by Jiang Xiaohua et al. in the article “Method for Detecting Salmonella by Using Metal-Organic Framework Material-Nucleic Acid Aptamer Fluorescence” (Journal of Instrumental Analysis Journal of Instrumental Analysis, No. 5, 2018), based on the fluorescence quenching features of metal-organic framework material (Uio-66-NH2) and adsorption of nucleic acid aptamers, and combining the high affinity and high specificity recognition ability of the nucleic acid aptamers, a fluorescent biosensor is constructed for detection Salmonella. When Salmonella and aptamers modified by fluorescein are adsorbed onto the surface of the material, fluorescence of the fluorescein is quenched due the electron transfer induced by the material. If Salmonella exists in the solution, Salmonella is specifically combined with its aptamer and is desorbed from the surface of the material, the electron transfer process between the material and the fluorescein is cut off, and the fluorescence of the fluorescein recovers. The signal of the fluorescence sensor constructed based on this principle is in a desirable linear relation with a logarithm of a Salmonella concentration in the range of 101-105 cfu/mL, and a detection limit (S/N=3) is 7 cfu/mL. The method has the spike recovery rate of 90.0%-108.0% when applied to detection of Salmonella in shrimp samples. The sensor has desirable selectivity and sensitivity to Salmonella.

### SUMMARY

Objective of the present invention: in order to overcome a complicated preparation process required by synthesis of a metal nanoprobe in the prior art and toxic and side effects in diagnosis and treatment of a pathogenic microorganism, an objective of the present invention is to provide a nucleic acid functionalized metal nanoprobe. Metal cations and nucleic acid molecules are mixed and cultivated to generate a deoxyribonucleic acid (DNA) or ribonucleic acid (RNA) composite nanostructure, co-incubating is performed with the pathogenic microorganism, the composite nanostructure enters pathogenic microorganism cells through electrostatic adsorption, and is taken as a template, and a fluorescent nanoprobe is synthesized by self-assembly in situ relying on unique intracellular microenvironment of high-level oxidizing and reducing substances of the pathogenic microorganism. Rapid detection and accurate killing are achieved, and the features of a strong targeting effect, simple and easy operation, etc. are achieved.

According to the probe, a metal soluble salt solution with desirable biocompatibility is mixed with exogenous DNA or RNA molecules to generate a DNA or RNA composite nanostructure; co-incubating is performed with a pathogenic microorganism, the composite nanostructure enters pathogenic microorganism cells through electrostatic adsorption, and unique microenvironment of the pathogenic microorganism is used to promote in-situ synthesis of the intelligent biological probe.

Technical solution: in order to solve the above technical problems, the present disclosure delivers exogenous nucleic acid molecules into the pathogenic microorganism based on high-level oxidizing and reducing substances in the pathogenic microorganism cells, and self-assembles in situ the nanoprobe of programmable nucleic acid biomolecules, as described specifically as follows:
according to a nucleic acid functionalized metal nanoprobe, nucleic acid molecules and metal cations with desirable biocompatibility form a gene-metal cation conjugate by electrostatic adsorption, and the gene-metal cation conjugate is co-incubated with pathogenic microorganism, pathogenic bacteria and viral cells to self-assemble in situ the nanoprobe with an average diameter of 2.3 nm.

A preparation method for the nucleic acid functionalized metal nanoprobe includes:
step 1, fully mixing nucleic acid fragments with a diluted nucleic acid intercalator SYBR Green I (2.5×), and placing a mixture at a room temperature to react in dark for 30 min;
the nucleic acid fragments include a DNA fragment or an RNA fragment or a related gene fragment synthesized by a chemical method; and
the RNA fragment is self-assembled RNA fragment formed by denaturation and gradient annealing.
step 2, adding a metal soluble salt solution with desirable biocompatibility into the above solution, and fully mixing a mixture to obtain a mixed solution A of metal cations and nucleic acid molecules;
the metal soluble salt is one or a combination of any several solutions of water soluble Mn²⁺, chloroauric acid, copper chloride, magnesium chloride, zinc gluconate, silver nitrate or ferrous chloride, and the soluble metal salt has a final concentration of 10 μmol/L-300 μmol/L, preferably 100 μmol/L. When the used metal cations are ferrous chloride, the obtained nucleic acid functionalized metal nanoprobe may play a targeted guiding role under the action of external magnetic field. Excellent biocompatibility means that metal cations obtained by hydrolysis of the metal soluble salt water may not cause damage to normal cells of human body and have no toxic or side effects on the normal cells.
Step 3, mixing the mixed solution A obtained in step 2 with pathogenic microorganism cells, and continuously incubating a mixture in a constant-temperature shaking table for 0.5 h-12 h to obtain a mixed solution B.

The pathogenic microorganism is Escherichia coli or Staphylococcus aureus.
Step 4, centrifuging the mixed solution B at a speed of 2000 r/min-5000 r/min to extract incubated pathogenic microorganism cells, and washing incubated cells with sterile water 3-5 times; and
step 5, activating washed incubated pathogenic microorganism cells with a laser confocal fluorescence microscope, performing fluorescence imaging detection, and applying activated pathogenic microorganism cells to the pathogenic microorganism under external physical intervention such as a magnetic field, near infrared for a targeting effect.

Compared with a method in the prior art, the present disclosure has the following advantages and effects:
(1) according to the present disclosure, the nucleic acid molecules and the metal cations with desirable biocompatibility form the gene-metal cation conjugate by electrostatic adsorption, and the gene-metal cation conjugate is co-incubated with the pathogenic microorganism, pathogenic bacteria and viral cells to self-assemble and synthesize in situ metal fluorescent or magnetic nanoparticles. Activating is performed with a laser confocal fluorescence microscope for fluorescence imaging of the pathogenic bacteria cells.
(2) The present disclosure may achieve accurate targeted marking and real-time rapid detection of the pathogenic microorganism and pathogenic bacteria, and has the features of high specificity, simplicity, convenience, etc.
(3) The nucleic acid functionalized metal nanoprobe of the present disclosure is combined with physical interventions such as photoelectricity, the magnetic field and the near infrared, has a desirable antibacterial effect, and may be used for targeted intervention of infectious diseases such as lung infection, intestinal infection and influenza.

### BRIEF DESCRIPTION OF THE DRAWINGS

FIG. 1 is a transmission electron microscope micrograph of a nanoprobe obtained in Example 1, where the nanoprobe has a diameter of 1.7 nm-2.6 nm and an average diameter of 2.3 nm;

FIG. 2 is a comparison diagram of fluorescence intensities of metal cations of different concentrations, where a signal intensity increases with increase of the concentration of the metal cations, the signal intensity reaches a maximum intensity when the concentration reaches 100 μmol/L, and the signal intensity remains basically unchanged with the concentration increasing, such that an optional concentration of the metal cations is 100 μmol/L;

FIG. 3 is a comparison diagram of germicidal effects of metal cations of different concentrations, where the germicidal effect is enhanced with increase of the concentration of the metal cations, and almost all bacteria are killed when the concentration reaches 100 μmol/L;

FIG. 4 is a comparison diagram of fluorescence intensities of different metal cation solutions, where except for a blank group, other experimental groups have slightly different signal intensities, but all have a desirable signal effect; and

FIG. 5 is a comparison diagram of germicidal effects of different metal cation solutions, where except for a blank group, all the other experimental groups show a strong germicidal effect.

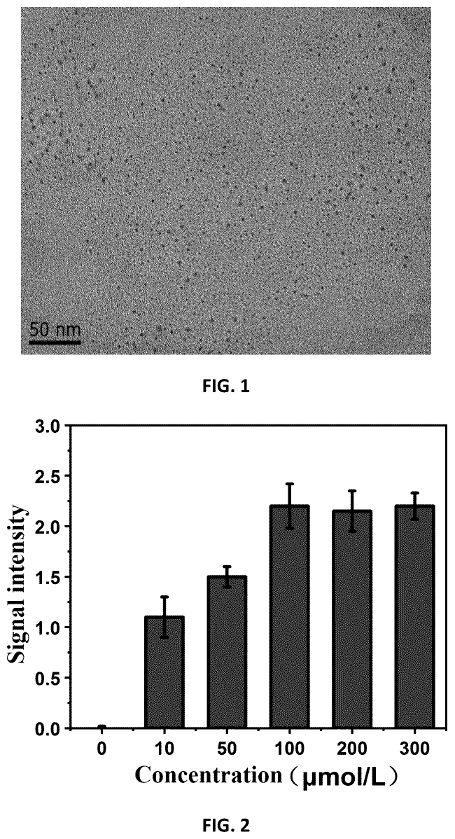

### DETAILED DESCRIPTION OF THE EMBODIMENTS

In order to further understand the present disclosure, technical solutions in the present disclosure will be described below clearly and comprehensively in conjunction with specific examples of the present disclosure.

Unless otherwise specified, reagents and instruments involved in the examples of the present disclosure are all commercially available products and can be purchased through commercial channels.

All metal cation solutions used in this experiment have been tested for cytotoxicity, and are all common metal cation solutions with desirable biocompatibility.

A kind screening experiment of metal cations is as follows: Human normal liver cells (L02) are taken as an example, and cytotoxicity of different metal cations on mammalian cells is evaluated by MTT assay. L02 cells are inoculated into a 96-well plate at a density of 0.5×10⁵ cells/mL, 100 μL per well, and are cultured at 37° C. for 8 h (5.0% CO₂). 100 μL of culture media containing different metal cations are added to each well, and culturing continues for 24 h. 20 μL of 5 mg/ml MTT solution is added to each well, and culturing continues for 4 h. After culturing, 150 μL of dimethyl sulfoxide is added into each well, and horizontal oscillation is performed for 10 min to completely dissolve a reactant of MTT. An ultraviolet absorption intensity at 490 nm is measured with a microplate reader, and a measured value is corrected using a blank hole merely containing a medium instead of cells. The cell survival rate (%) is expressed as the ratio of a measured value of an experimental group to a measured value of a control group (without addition of gold nanoclusters).

A result shows that chloroauric acid, zinc gluconate, silver nitrate, ferrous chloride or mixed metal salt of ferrous chloride and chloroauric acid as well as mixed metal salt of ferrous chloride and zinc gluconate all show desirable biocompatibility, and the cell survival rate reaches 90% or above.

### Example 1

A preparation method for a nucleic acid functionalized metal nanoprobe includes:
(1) deoxyribonucleic acid (DNA) molecules are fully mixed with a diluted nucleic acid intercalator SYBR Green I (2.5×), and a mixture is placed at a room temperature to react in dark for 30 min.
(2) a reaction product of step (1) is fully mixed with 100 μmol/L chloroauric acid solution to obtain a mixed solution A.
(3) the mixed solution A and Escherichia coli are continuously co-incubated in a constant-temperature shaking table for 1 h-12 h to obtain a mixed solution B. A normal control group (a chloroauric acid solution having the same concentration as the experimental group is merely added) and a blank group (an Escherichia coli suspension without any treatment) are set. After incubation, a small amount of the above mixed solution are dripped into the slide glass, and mounting is performed with a cover glass.
(4) A slide glass is placed under a laser confocal fluorescence microscope to be activated. Further, the above mixture is irradiated with 808 nm laser for 5-10 min, is cultured on a solid medium, and counted. A result shows that Escherichia coli in the experimental group shows strong fluorescence and almost all of Escherichia coli is killed, Escherichia coli in the normal control group shows weak fluorescence and most of Escherichia coli is killed, and the blank group has no change.

Meanwhile, normal L02 cells are taken as experimental objects for investigating an effect of the mixed solution A on human normal cells. A result shows that compared with the experimental group of Escherichia coli, no fluorescence signal is detected and the cells are in desirable living condition, indicating that the metal nanoprobe may not be synthesized in the human normal cells and have better targeting specificity.

### Example 2 Effects of Different Nucleic Acid Fragments on an Experimental Result

An experimental method is the same as that of Example 1 except that effects of different nucleic acid fragments on the result are investigated.

The nucleic acid fragments investigated include: \textcircled{1} DNA molecules, \textcircled{2} self-assembled ribonucleic acid (RNA) fragments formed after denaturation and gradient annealing (RNA molecules are denatured at 90° C. for 1 min and are immediately placed on ice for being cooled. Then the RNA molecules are subjected to gradient annealing treatment, i.e. 70° C.-50° C., 50° C.-37° C., 37° C.-4° ° C.).

A result shows that compared with the experimental group of DNA molecules, although a fluorescence intensity of an experimental group with added RNA fragments decreases slightly, a fluorescence signal is also very strong and a desirable antibacterial effect is shown.

It may be seen that the RNA fragments may also be used in synthesis of the metal nano-probe like DNA molecules, and show desirable detection and sterilization effects.

### Example 3 Effects of Different Metal Cations on an Experimental Result

An experimental method is the same as that of Example 1 except that effects of different metal cations on the result are investigated.

The metal cations investigated include (with a concentration of 100 μmol/L): \textcircled{1} chloroauric acid, \textcircled{2} zinc gluconate, \textcircled{3} silver nitrate, \textcircled{4} a mixture of chloroauric acid and ferrous chloride, and \textcircled{5} a mixture of zinc gluconate and ferrous chloride.

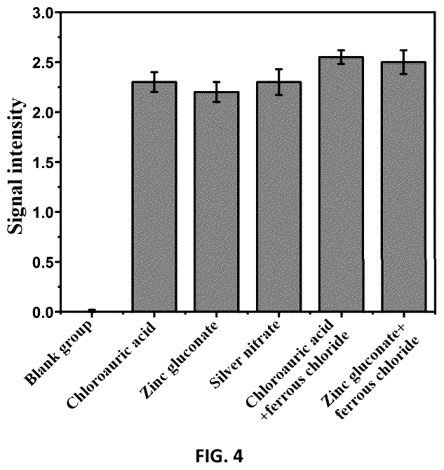

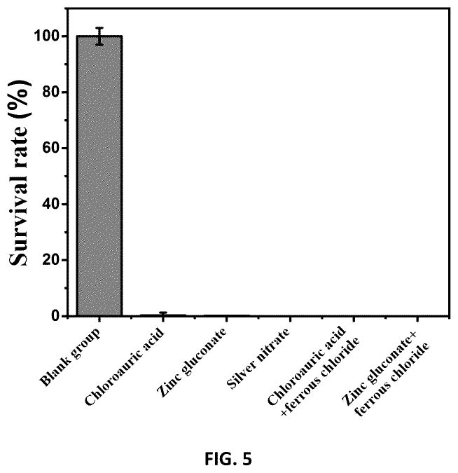

A result shows that it may be seen from FIGS. 4 and 5, although phenomena of different metal cation solutions are slightly different, the metal cation solutions all show a strong signal intensity and a desirable antibacterial effect.

It may be seen that the metal cations used in the experiment have desirable detection and sterilization effects.

### Example 4 Effects of a Concentration of Metal Cations on an Experimental Result

An experimental method is the same as that of Example 1 except that effects of different concentrations of metal cations on the result are investigated. The metal cations (chloroauric acid) investigated have concentration of 0 μmol/L, 10 μmol/L, 50 μmol/L, 100 μmol/L, 200 μmol/L and 300 μmol/L separately.

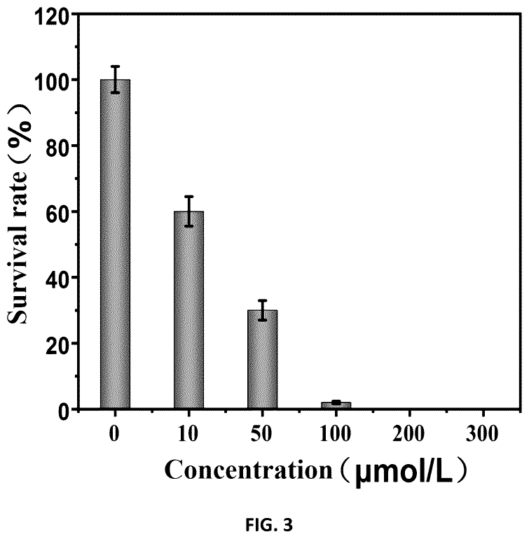

A result shows that with increase of the concentration of metal cations (chloroauric acid), the signal intensity is enhanced, and when the concentration reaches 100 μmol/L, the signal intensity does not increase (see FIG. 2) any more. And with increase of the concentration of the metal cations, the sterilization effect is gradually enhanced (see FIG. 3).

It may be seen that the concentration affects the action of metal cations to a certain extent, and with the increase of the concentration, detection and treatment effects are enhanced.

### Example 5 Effects of a Nucleic Acid Functionalized Metal Nanoprobe on Different Pathogenic Bacteria

An experimental method is the same as that of Example 1 except that a mixture A in step (3) is incubated with different bacteria, and bacteria investigated include \textcircled{1} Escherichia coli and \textcircled{2} Staphylococcus aureus.

A result shows that \textcircled{1} Escherichia coli and \textcircled{2} Staphylococcus aureus shows strong fluorescence phenomenon and almost all of Escherichia coli and Staphylococcus aureus are killed. It may be seen that the nucleic acid functionalized metal nanoprobe obtained by the present disclosure is used for targeted intervention of related diseases such as lung infection, intestinal infection and influenza.

### Example 6 Animal Experiment

1. Sample preparation: reference is made to the preparation method of Example 1 except that metal salt is obtained by co-incubating a mixed solution of zinc gluconate solution and ferrous chloride solution with equal concentration.
2. Experimental process: a sample obtained by co-incubation is injected in situ from a tail vein or lesion of a mouse infected with skin or pneumonia, and a control group (a nucleic acid fragment without metal cations added) is set. The above experimental mouse is observed by real-time multi-modal (fluorescence, magnetic resonance imaging (MRI), ultrasound, computed tomography (CT), etc.) imaging in situ with a small animal living imager. And, light and heat are used to physically intervene the lesion, and changes and ablation of the lesion are recorded. Compared with the control group, an imaging signal may quickly identify a site of the lesion of the mouse in the experimental group and concentrate in this area, and related disease disappears after physical therapy.

What are described above are merely preferred embodiments of the present disclosure, these examples shall be understood to be merely used for describing the present disclosure but not limiting the scope of the present disclosure, and for those skilled in the art, various modifications and embellishments of the present disclosure made without departing from principles of the present disclosure shall fall within the scope defined by the appended claims of the present application.

What is claimed is:

1. A nucleic acid functionalized metal nanoprobe, wherein nucleic acid molecules and metal cations with desirable biocompatibility form a gene-metal cation conjugate by electrostatic adsorption, and the gene-metal cation conjugate is co-incubated with a pathogenic microorganism to self-assemble in situ a fluorescent nanoprobe with a particle size of 1.7 nm-2.6 nm;
a raw material of the metal cations is selected from one or a mixture of any several solutions of water soluble Mn²⁺, chloroauric acid, copper chloride, magnesium chloride, zinc gluconate, silver nitrate or ferrous chloride; and
the pathogenic microorganism is Escherichia coli or Staphylococcus aureus.

2. A preparation method for the nucleic acid functionalized metal nanoprobe according to claim 1, comprising
step 1, fully mixing nucleic acid fragments with a nucleic acid intercalator SYBR Green I, and placing a mixture at a room temperature to react in dark for 30 min;
step 2, adding a metal soluble salt solution into a reaction solution in step 1, and fully mixing a mixture to obtain a mixed solution A of metal cations and nucleic acid molecules;
step 3, mixing the mixed solution A obtained in step 2 with a pathogenic microorganism, and continuously incubating a mixture in a constant-temperature shaking table for 0.5 h-12 h to obtain a mixed solution B;
step 4, centrifuging the mixed solution B to extract an incubated pathogenic microorganism, and washing incubated cells with sterile water 3-5 times; and
step 5, activating washed incubated pathogenic microorganism cells with a laser confocal fluorescence microscope, performing fluorescence imaging detection, and applying activated pathogenic microorganism cells to the pathogenic microorganism under external physical intervention.

3. The preparation method for the nucleic acid functionalized metal nanoprobe according to claim 2, wherein in step 1, the nucleic acid fragments comprise a deoxyribonucleic acid (DNA) fragment or an ribonucleic acid (RNA) fragment or a related gene fragment synthesized by a chemical method, and the RNA fragment is self-assembled RNA fragment formed by denaturation and gradient annealing.

4. The preparation method for the nucleic acid functionalized metal nanoprobe according to claim 2, wherein in step 2, the metal soluble salt is one or a mixture of any several solutions of water soluble Mn²⁺, chloroauric acid, copper chloride, magnesium chloride, zinc gluconate, silver nitrate or ferrous chloride, and the soluble metal salt has a concentration of 10 μmol/L-300 μmol/L.

5. The preparation method for the nucleic acid functionalized metal nanoprobe according to claim 2, wherein in step 5, the external physical intervention is magnetic field or infrared heating, and the pathogenic microorganism is Escherichia coli or Staphylococcus aureus.
